(19) United States
(12) Patent Application Publication
(10) Pub. No.: US 2005/0164019 A1
(43) Pub. Date: Jul. 28, 2005

(54) Charge transfer-promoting materials and electronic devices incorporating same

(75) Inventors: Jie Liu, Niskayuna, NY (US); Anil Raj Duggal, Niskayuna, NY (US); Larry Neil Lewis, Scotia, NY (US); Daniel Gerard Colombo, Guilderland, NY (US); James Anthony Cella, Clifton Park, NY (US); Joseph John Shiang, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/761,696

(22) Filed: Jan. 22, 2004

(51) Int. Cl. B32B 15/08; H01B 1/00; H05B 33/00

(52) U.S. Cl. 428/457; 428/690; 428/418; 428/447; 428/917; 313/504; 252/519.2; 257/40

(57) ABSTRACT

A charge transfer-promoting material comprises a material having a formula selected from the group consisting of AM, Aⁿ⁻Mⁿ⁺ and {A-R³}ⁿ⁻Mⁿ⁺; wherein A is a fused ring radical having from 2 to 4 rings, inclusive; crown ethers; cryptands; or macrocyclic polyamines; M is a metal; R³ is selected from the group consisting of alkoxy silane, carboxylic acid, thiol, amine, phosphine, amide, imine, ester, anhydride, and epoxy, and is covalently attached to A; and n is an integer number selected from the group consisting of 1, 2, and 3. Electronic devices comprise such a charge transfer-promoting material for enhancing the charge injection or transport between an electrode and an electronically active material.

### BACKGROUND OF THE INVENTION

The present invention relates to electronic devices having charge injection materials. In particular, the present invention relates to such devices having enhanced charge injection into an electronically active material.

Efficient operation of electronic devices depends, among other things, efficient transport of charges between an electrode and an adjacent medium. Opto-electronic devices comprise a class of electronic devices and are currently used in several applications that incorporate the principle of conversion between optical energy and electrical energy. Electroluminescent (“EL”) devices, which are one type of such devices, may be classified as either organic or inorganic and are well known in graphic display and imaging art. EL devices have been produced in different shapes for many applications. Inorganic EL devices, however, typically suffer from a required high activation voltage and low brightness. On the other hand, organic EL devices (“OELDs”), which have been developed more recently, offer the benefits of lower activation voltage and higher brightness in addition to simple manufacture, and, thus, the promise of more widespread applications.

An OELD is typically a thin film structure formed on a substrate such as glass or transparent plastic. A light-emitting layer of an organic EL material and optional adjacent organic semiconductor layers are sandwiched between a cathode and an anode. The organic semiconductor layers may be either hole (positive charge)-injecting or electron (negative charge)-injecting layers and also comprise organic materials. The material for the light-emitting layer may be selected from many organic EL materials that emit light having different wavelengths. The light-emitting organic layer may itself consist of multiple sublayers, each comprising a different organic EL material. State-of-the-art organic EL materials can emit electromagnetic (“EM”) radiation having narrow ranges of wavelengths in the visible spectrum. Unless specifically stated, the terms “EM radiation” and “light” are used interchangeably in this disclosure to mean generally radiation having wavelengths in the range from ultraviolet (“UV”) to mid-infrared (“mid-IR”) or, in other words, wavelengths in the range from about 300 nm to about 10 micrometers.

Reducing or eliminating barriers for charge injection between the organic EL layer and an electrode contributes greatly to enhance the device efficiency. Metals having low work functions, such as the alkali and alkaline-earth metals, are often used in a cathode material to promote electron injection. However, these metals are susceptible to degradation upon exposure to the environment. Therefore, devices using these metals as cathode materials require rigorous encapsulation. In addition, these metals can diffuse rapidly into an adjacent organic EL layer, leading to device performance decay.

Other opto-electronic devices, such as photovoltaic cells, can also benefit from a lower barrier for electron transport across the interface between an active layer and an adjacent cathode.

Therefore, it is desirable to provide materials that efficiently allow charges to move between an electrode and an adjacent material and, at the same time, substantially preserve the long-term stability of the device.

### BRIEF SUMMARY OF THE INVENTION

In general, the present invention provides a charge-donating, charge-transferring, or charge transfer-promoting material (herein collectively termed “charge transfer-promoting materials”) that is capable of donating, transferring, or promoting the transfer of a charge to an adjacent material.

In one embodiment, the charge transfer-promoting material comprises an organic compound interacting with a metal or a metal halide.

In another embodiment, the organic compound is a polarizable or ionizable moiety. Such a moiety can carry a system of delocalized charges.

In still another embodiment, the charge transfer-promoting material enhances a transport of charges from a first material to a second material.

In still another embodiment, a charge transfer-promoting material comprises a material having at least a formula selected from the group consisting of AM, and AMⁿ⁺X⁻ₙ; wherein A is an organic compound selected from the group consisting of fused ring radicals having from 2 to 5 rings, inclusive, and derivatives thereof; M is at least a metal selected from the group consisting of alkali metals, alkaline-earth metals, scandium, yttrium, and metals of lanthanide series; X is at least one of the halogen elements; and n is an integer selected from the group consisting of 1, 2, and 3.

In still another embodiment, A is selected from the group consisting of crown ethers, cryptands, and derivatives thereof.

In still another embodiment, A is selected from the group consisting of macrocyclic polyamine compounds and derivatives thereof.

In still another embodiment, the charge transfer-promoting material is disposed between the first material and the second material to effect such an enhancement of charge transport from the first material to the second material.

In still another embodiment, the first material comprises an electrode of an electronic device, and the second material is an electronically active material.

Other features and advantages of the present invention will be apparent from a perusal of the following detailed description of the invention and the accompanying drawings in which the same numerals refer to like elements.

### BRIEF DESCRIPTION OF THE DRAWINGS

It should be understood that the drawings accompanying this disclosure are not drawn to scale.

FIG. 1 illustrates schematically an electronic device incorporating a charge transfer-promoting material.

FIG. 2 illustrates schematically an electronic device, wherein the charge transfer-promoting material forms a transition region with the electronically active material.

FIG. 3 illustrates schematically an electronic device that includes a charge transfer-promoting material and a hole injection enhancement layer.

FIG. 4 illustrates schematically an electronic device that includes a charge transfer-promoting material, a hole injection enhancement layer, and a hole transport layer.

FIG. 5 illustrates schematically an electronic device that includes a charge transfer-promoting material and an electron injecting and transporting enhancement layer.

FIG. 6 illustrates schematically an organic EL device that includes an organic photoluminescent material.

FIG. 7 schematically an organic EL device that includes an organic photoluminescent material and an inorganic photoluminescent material.

FIG. 8 shows the higher current injected into an organic electronic device having a layer of sodium anthracenide adjacent to the cathode.

FIG. 9 shows the higher current injected into an organic electronic device having a layer of potassium triethoxysilylnaphthalene (“KNTES”) adjacent to the cathode.

FIG. 10 shows the higher brightness of an organic EL device having a layer of KNTES adjacent to the cathode.

FIG. 11 show the effect of different loadings of sodium anthracenide doped into the organic EL layer of an organic EL device.

FIG. 12 illustrates a PV cell incorporating a charge transfer-promoting material of the present invention.

FIG. 13 illustrates a PV cell incorporating a charge transfer-promoting material of the present invention that can absorb light from both surfaces.

### DETAILED DESCRIPTION OF THE INVENTION

In general, the present invention provides a charge transfer-promoting material that is capable of enhancing the donation or transfer of a charge from one material to an adjacent material. Thus, a charge transfer-promoting material of the present invention also is capable of enhancing the transport or injection of charges from a first medium to a second medium. A charge transfer-promoting material of the present invention comprises an organic compound interacting with a metal or an organic compound interacting with metal halide. For example, the organic compound is capable of interacting by binding with an atom or an ion of the metal. In this disclosure, the term “interacting” or “interaction” means capturing, holding, stabilizing in place, or otherwise forming a bond with a metal atom or ion. In one embodiment, the organic compound is capable of sharing electrons with, and stabilizing, said metal ion. In one embodiment, the organic compound is a polarizable or ionizable moiety. In another embodiment, the organic compound is capable of forming a complex with the metal.

In one embodiment, the moiety can be characterized by its ability to support delocalized charges, such as delocalized electrons.

In another embodiment, the charge transfer-promoting material is an electron transfer-promoting material that enhances electron injection from a cathode of an electronic device into an adjacent electronically active material.

In one embodiment, the electron transfer-promoting material comprises a compound having at least a formula selected from the group consisting of AM, and AMⁿ⁺X⁻ₙ; wherein A is an organic compound or moiety selected from the group consisting of fused ring radicals having from 2 to 5 rings, inclusive, and derivatives thereof; M is at least a metal selected from the group consisting of alkali metals, alkaline-earth metals, scandium, yttrium, and metals of lanthanide series; X is at least one of halogen elements; and n is an integer selected from the group consisting of 1, 2, and 3. For example, A can be a fused aromatic ring radical having from 2 to 5 rings, inclusive. Non-limiting examples of fused aromatic rings that are applicable with the present invention are naphthalene, anthracene, phenanthrene, triphenylene, chrysene, pyrene, dibenza{a,h}anthracene, perylene, fluorene, fluorenone, and 2,9-dimethyl-4,7-diphenyl-1,10-phenanthroline (“BCP”). Other examples of fused rings include five-member rings. In one embodiment, M is an alkali metal; preferably, lithium, sodium, potassium, or cesium; and more preferably, lithium, sodium, or potassium. A material of this class, having a formula of AM, can be made by reacting a fused-ring compound, such as a fused-ring aromatic compound having the desired number of aromatic rings with a metal, such as an alkali metal. For example, the manufacture of sodium anthracenide, an exemplary charge transfer-promoting material of the present invention, is described in Example 1.

### EXAMPLE 1

### Manufacture of Sodium Anthracenide

An amount of 0.2 g of anthracene was combined with 0.05 g sodium in 5 ml of ethyleneglycoldimethylether (“DME”) in a Schlenk tube. The solution was subjected to three freeze/degas/thaw cycles and then the contents were stirred at ambient temperature under vacuum. A deep blue solution containing sodium anthracenide was obtained.

In another embodiment, the charge transfer-promoting material has a moiety that promotes a formation of a bond with a surface, such as an alkoxy silane, a carboxylic acid, a thiol, an amine, a phosphine, an amide, an imine, an ester, an anhydride, or an epoxy group. In general, such a charge transfer-promoting compound has a formula of {A-R³}ⁿ⁻Mⁿ⁺; wherein A is an organic moiety, such as a fused ring radical, a crown ether, a cryptand, a macrocyclic polyamine, such as 1,4,7,10-tetraazacyclododecane (also known as “cyclen”); 1,4,7-triazacyclononane; 1,4,8,11-tetraazacyclotetradecane (also known as “cyclam”); 1-oxa-4,7,10-triazacyclododecane; or derivatives thereof; R³ is alkoxy silane, a carboxylic acid, a thiol, an amine, a phosphine, an amide, an imine, an ester, an anhydride, or an epoxy group that is covalently bound to A; M is a metal selected from the group consisting of alkali metals, alkaline-earth metals, scandium, yttrium, and metals of the lanthanide series; and n is an integer number selected from the group consisting of 1, 2, and 3. R³ may be covalently bound to A through a straight or branched alkylene radical having from 1 to 5, inclusive, carbon atoms.

Methods for covalently attaching a moiety having a heteroatom to an organic compound or moiety are known in the art. For example, methods for attaching a carboxylic acid, a thiol, an amine, a phosphine, an amide, an imine, an ester, an anhydride, or an epoxy group to an organic moiety are disclosed in Jerry March, “Advanced Organic Chemistry,” 4^{th} ed.; pp. 1181-83, 1196, 1204-05, 413, 417, 896-97, 392-98, 400-02, 1227, 974, 387; John Wiley & Sons; New York; New York (1992).

In one embodiment, the electron-donating material has a formula of {A-R¹—Si—(OR²)₃}ⁿ⁻Mⁿ⁺; wherein A is a fused aromatic ring radical having from 2 to 5 rings, inclusive; R¹ is a straight or branched alkylene radical having from 1 to 5, inclusive, carbon atoms; R² is hydrogen or a straight or branched alkyl radical having from 1 to 5 carbon atoms, inclusive; M is a metal selected from the group consisting of alkali metals, alkaline-earth metals, scandium, yttrium, and metals of the lanthanide series; and n is an integer number selected from the group consisting of 1, 2, and 3. A is preferably a fused aromatic ring radical having 2 or 3 aromatic rings. M is preferably an alkali metal; more preferably, lithium, sodium, potassium, or cesium; and most preferably, lithium, sodium, or potassium. A material of this class readily forms covalent bonds with surface atoms of typical cathode materials, such as transition metals and metals of Group-IIIB of the Periodic Table, efficiently to transport electrons therefrom. It should be understood that the names of the Groups of the Periodic Table, as used herein, are those designated by the International Union of Pure and Applied Chemistry (“IUPAC”). Potassium triethoxysilylnaphthalene, which is an exemplary compound of this class of materials, was synthesized in a two-step process, as described in Example 2.

### EXAMPLE 2

### Manufacture of Potassium Triethoxysilylnapthalene

In the first step, 2-vinylnaphthalene was reacted with 1.2 equivalent of triethoxysilane in toluene in the presence of catalytic amounts of Karstedt's platinum solution to yield triethoxysilylnaphthalene (“NTES”) according to Equation 1. Analysis of the reaction products by GCMS (gas chromatography-mass spectroscopy) indicated that the products consisted of two isomers, as shown in Equation 1. The NTES product was purified by vacuum distillation at 6 mm Hg and 155-160 C.

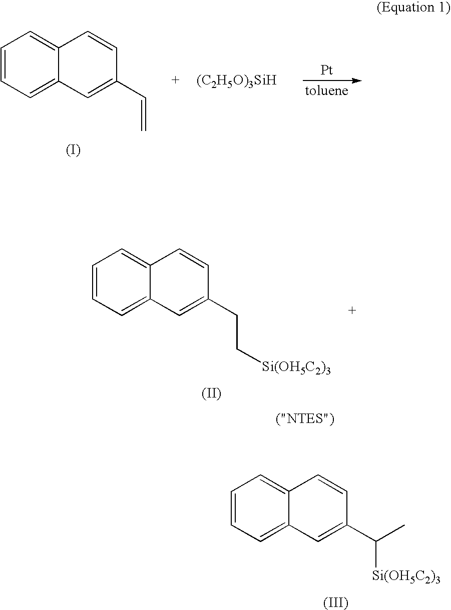

Although the starting material (compound I) is shown to have a —CH═CH₂ substituent, double-bond terminated hydrocarbon groups having 2 to 5 carbon atoms are suitable substituents. Other starting materials of the same general class of compounds may be represented by A-R⁴, wherein A is a fused ring radical having 2 to 5 rings, inclusive; and R⁴ is a double-bond terminated hydrocarbon group having 2 to 5 carbon atoms, inclusive.

In the second step, NTES was reacted with one equivalent potassium in ethyleneglycoldimethylether (“DME”) to yield a dark blue solution containing potassium triethoxysilylnaphthalene (“KNTES”), as shown in Equation 2.

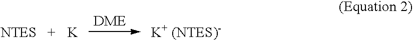

K⁺ (NTES)⁻ can be represented by {A-R¹—Si—O—(OR²)₃}ⁿ⁻Mⁿ⁺, wherein A is naphthalene radical (fused aromatic ring radical having 2 rings), R¹ is —CH₂—CH₂— or —CH(CH₃)— group, R₂ is C₂H₅—, M is potassium, and n is 1.

Other compounds of the same class may be made by replacing naphthalene with other compounds having fused aromatic rings.

In another embodiment, the electron transfer-promoting material is based on a crown ether compound or a derivative thereof; for example, a compound having the formula (IV) or (V): 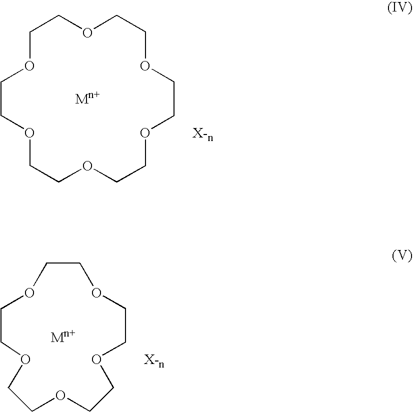
wherein X⁻ is a halide ion, and M and n are defined above. Compounds (IV) and (V) comprise a crown ether moiety and a metal halide having the formula MXₙ, wherein the metal ion Mⁿ⁺ is bound tightly with the crown ether moiety. For example, the crown ether moieties shown in (IV) and (V) are commonly known as 18-crown-6 (also known by the IUPAC name of 1,4,7,10,13,16-hexaoxacyclooctadecane) and 15-crown-5 (also known by the IUPAC name of 1,4,7,13-pentoxacyclopentadecane), respectively. Crown ethers are cyclic compounds, the structure of which comprises repeating units of —CH₂—CH₂—O—.

A substituted 15-crown-5 compound was made, which was useful as a charge transfer-promoting material of the present invention, as detailed in Example 3.

### EXAMPLE 3

### Manufacture of Alkoxysilyl-Substituted 15-crown-5

The hydroxymethyl analog of 15-crwon-5 (VI) was converted into the allyl ether (VII), and then hydrosilylation was used to prepared the alkoxysilyl-substituted 15-crown-5 (compound VIII).

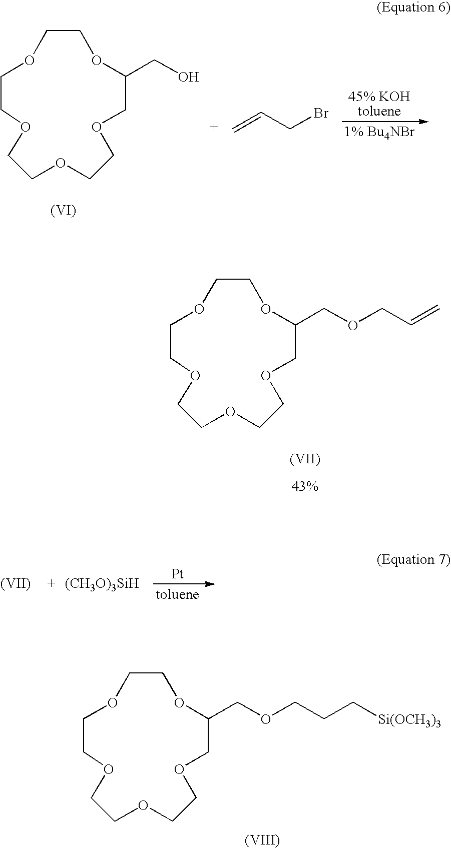

The mass spectrum of VIII clearly showed the molecular ion at 412 amu. The mass spectrum of VII showed the expected molecular ion at 291 amu and also showed the molecular ion of sodium- and potassium-containing crown ethers at 313 and 329 amu respectively.

Hydroxymethyl 15-crown-5 (VI) (1 g, 4 mmol) was combined with allyl bromide (0.5 g) toluene (20 ml), 45% aqueous KOH (20 ml) and tetrabutylammonium bromide (0.1 g) in a flask equipped with a reflux condenser. The mixture was stirred and heated to reflux for 12 h. After cooling, two layers were obtained and the top layer was separated with a separatory funnel. The bottom (aqueous layer) was washed three times with toluene (20 mL) and then all the toluene solutions were combined, dried with MgSO₄, filtered and then toluene was removed in vacuo. A colorless oil, VII, was obtained from this procedure.

Compound VII (0.5 g, 1.72 mmol) was combined with (CH₃O)₃SiH (0.25 g), 5 mL Of toluene and 5 μL of 5% Pt Karstdet Pt catalyst solution. The mixture was heated at around 60° C. for 2 h. ¹H NMR and GC/MS (gas chromatography/mass spectroscopy) analysis were consistent with formation of compound VIII.

In another embodiment, a naphthalenide or an anthracenide derivative (such as a product made according to the process of Equations 1 and 2) may be attached to a crown ether, such as the organic moieties of compounds IV and V, to provide an electron-transfer promoting material that strongly retains alkali metal ions through an interaction, complexation, or chelation with the oxygen atoms of the crown ether and through an interaction or binding with the fused ring moiety.

An electron (charge)-transfer promoting material of the present invention, such as an alkali triethoxysilylnaphthalene or a alkoxysilyl-substituted crown ether having the formula VIII can attach well to a surface of an electrode through a covalent bond resulting from a reaction between a alkoxysilyl group and any reactive surface group (such as an oxide) of the electrode. Such a covalent bond efficiently assists electron injection and transport from the electrode into an adjacent medium.

In another embodiment, the complexing ligand of a charge transfer-promoting material of the present invention is based on one of the cryptands. The structure of these compounds comprises repeating units of —CH₂—CH₂—O—, combined with polyether bridges ending at nitrogen atoms in the macrocyclic structure. For example, {1,1,1}-cryptand (IX), {2,2,1}-cryptand (X), and {3,2,2}-cryptand are shown immediately below.

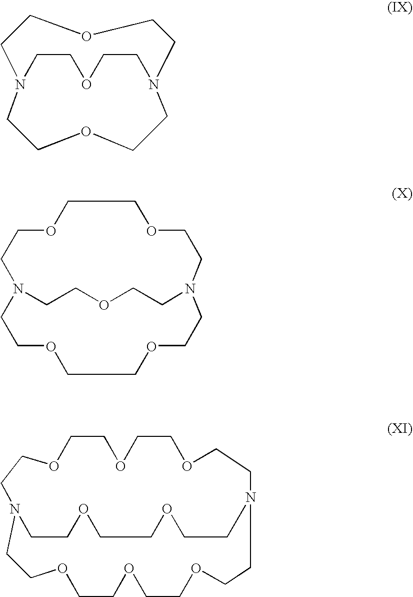

A charge transfer-promoting material of the present invention, for example, can comprise one of the cryptands (IX, X, or XI), shown above, complexing with a metal or a metal ion of a metal halide. Such metal is selected from the group consisting of alkali metals, alkaline-earth metals, scandium, yttrium, and metals of the lanthanide series.

In another embodiment of the present invention, a charge transfer-promoting material can comprise, for example, a macrocyclic polyamine compound, interacting with a metal or a metal ion of a metal halide. Such metal is selected from the group consisting of alkali metals, alkaline-earth metals, scandium, yttrium, and metals of the lanthanide series. Non-limiting examples of such macrocyclic polyamine compounds are 1,4,7,10-tetraazacyclododecane; 1,4,7-triazacyclononane; 1,4,8,11-tetraazacyclotetradecane; 1-oxa-4,7,10-triazacyclododecane; and derivatives thereof. The derivatives of these macrocyclic polyamine compounds include those compounds having one or more substituents attached to one or more of the nitrogen atoms. Such substituents can include alkyl groups having 1 to 3 carbon atoms, inclusive; and carboxylic acid moieties.

Unsubstituted or substituted crown ethers (such as compound VIIII), cryptands, or macrocyclic polyamines can form a complex or a compound with a metal (such as an alkali metal, for example, potassium) or metal ion by reacting the metal or a metal halide (such as an alkali halide, for example potassium fluoride) in a suitable solvent, such as DME, THF (tetrahydrofuran), DEE (ethyleneglycol diethylether), or xylenes.

Electronic Devices Incorporating Charge Transfer-Promoting Materials

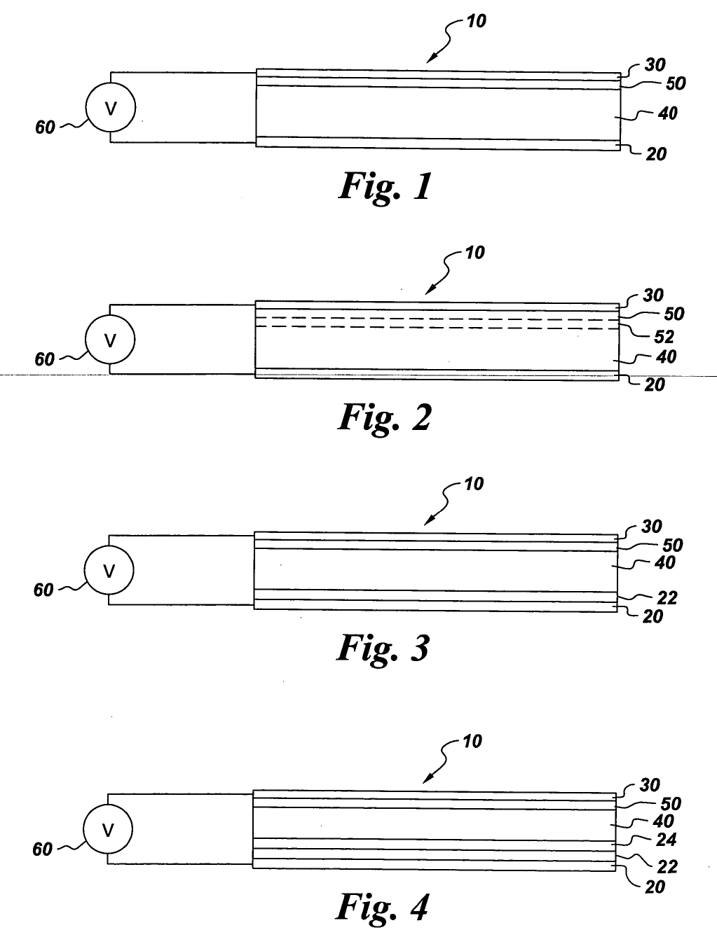

In one embodiment, an electron transfer-promoting material of the present invention is incorporated into an electronic device to enhance the electron transport from or to an electrode. For example, an organic electroluminescent (“EL”) device can benefit from an electron-donating material of the present invention, such as one of the materials disclosed above, which material is disposed between the cathode and the organic electroluminescent material of the device. FIG. 1 schematically illustrates such a device that comprises an electron transfer-promoting material of the present invention. The organic EL device 10 comprises: (a) an anode 20; (b) a cathode 30; (c) an organic EL material 40 disposed between anode 20 and cathode 30; and (d) an electron transfer-promoting material 50 disposed between cathode 30 and organic EL material 40. Organic EL material 40 emits light when a voltage from a voltage source 60 is applied across the electrodes 20 and 30. Electron transfer-promoting material 50 can form a distinct interface with organic EL material or a continuous transition region 52, as shown in FIG. 2, having a composition changing from substantially pure electron transfer-promoting material 50 to substantially pure organic EL material. Electron-donating material 50 can be deposited on an underlying material by a method selected from the group consisting of spin coating, spray coating, dip coating, roller coating, or ink-jet printing.

The anode 20 of organic EL device 10 comprises a material having a high work function; e.g., greater than about 4.4 eV, for example from about 5 eV to about 7 eV. Indium tin oxide (“ITO”) is typically used for this purpose. ITO is substantially transparent to light transmission and allows light emitted from organic electroluminescent layer 40 easily to escape through the ITO anode layer without being seriously attenuated. The term “substantially transparent” means allowing at least 50 percent, preferably at least 80 percent, and more preferably at least 90 percent, of light in the visible wavelength range transmitted through a film having a thickness of about 0.5 micrometer, at an incident angle of less than or equal to 10 degrees. Other materials suitable for use as the anode layer are tin oxide, indium oxide, zinc oxide, indium zinc oxide, zinc indium tin oxide, antimony oxide, and mixtures thereof. Anode layer 20 may be deposited on the underlying element by physical vapor deposition, chemical vapor deposition, or sputtering. The thickness of an anode comprising such an electrically conducting oxide can be in the range from about 10 nm to about 500 nm, preferably from about 10 nm to about 200 nm, and more preferably from about 50 nm to about 200 nm. A thin, substantially transparent layer of a metal is also suitable; for example, a layer having a thickness less than about 50 nm, preferably less than about 20 nm. Suitable metals for anode 20 are those having high work function, such as greater than about 4.4 eV, for example, silver, copper, tungsten, nickel, cobalt, iron, selenium, germanium, gold, platinum, aluminum, or mixtures thereof or alloys thereof. In one embodiment, it may be desirable to dispose anode 20 on a substantially transparent substrate, such as one comprising glass or a polymeric material.

Cathode 30 injecting negative charge carriers (electrons) into organic EL layer 40 and is made of a material having a low work function; e.g., less than about 4 eV. Low-work function materials suitable for use as a cathode are K, Li, Na, Mg, Ca, Sr, Ba, Al, Ag, In, Sn, Zn, Zr, Sc, Y, elements of the lanthanide series, alloys thereof, or mixtures thereof. Suitable alloy materials for the manufacture of cathode layer 30 are Ag—Mg, Al—Li, In—Mg, and Al—Ca alloys. Layered non-alloy structures are also possible, such as a thin layer of a metal such as Ca (thickness from about 1 to about 10 nm) or a non-metal such as LiF, covered by a thicker layer of some other metal, such as aluminum or silver. Cathode 30 may be deposited on the underlying element by physical vapor deposition, chemical vapor deposition, or sputtering. The Applicants unexpectedly discovered that an electron-donating material chosen from among those disclosed above lowered the work function of cathode materials, thus reducing the barrier for electron injection and/or transport into organic EL material 40.

Organic EL layer 40 serves as the transport medium for both holes and electrons. In this layer these excited species combine and drop to a lower energy level, concurrently emitting EM radiation in the visible range. Organic EL materials are chosen to electroluminesce in the desired wavelength range. The thickness of the organic EL layer 40 is preferably kept in the range of about 100 to about 300 nm. The organic EL material may be a polymer, a copolymer, a mixture of polymers, or lower molecular-weight organic molecules having unsaturated bonds. Such materials possess a delocalized π-electron system, which gives the polymer chains or organic molecules the ability to support positive and negative charge carriers with high mobility. Suitable EL polymers are poly(n-vinylcarbazole) (“PVK”, emitting violet-to-blue light in the wavelengths of about 380-500 nm) and its derivatives; polyfluorene and its derivatives such as poly(alkylfluorene), for example poly(9,9-dihexylfluorene) (410-550 nm), poly(dioctylfluorene) (wavelength at peak EL emission of 436 nm) or poly{9,9-bis(3,6-dioxaheptyl)-fluorene-2,7-diyl} (400-550 nm); poly(praraphenylene) (“PPP”) and its derivatives such as poly(2-decyloxy-1,4-phenylene) (400-550 nm) or poly(2,5-diheptyl-1,4-phenylene); poly(p-phenylene vinylene) (“PPV”) and its derivatives such as dialkoxy-substituted PPV and cyano-substituted PPV; polythiophene and its derivatives such as poly(3-alkylthiophene), poly(4,4′-dialkyl-2,2′-biothiophene), poly(2,5-thienylene vinylene); poly(pyridine vinylene) and its derivatives; polyquinoxaline and its derivatives; and poly quinoline and its derivatives. Mixtures of these polymers or copolymers based on one or more of these polymers and others may be used to tune the color of emitted light.

Another class of suitable EL polymers is the polysilanes. Polysilanes are linear silicon-backbone polymers substituted with a variety of alkyl and/or aryl side groups. They are quasi one-dimensional materials with delocalized σ-conjugated electrons along polymer backbone chains. Examples of polysilanes are poly(di-n-butylsilane), poly(di-n-pentylsilane), poly(di-n-hexylsilane), poly(methylphenylsilane), and poly{bis(p-butylphenyl)silane} which are disclosed in H. Suzuki et al., “Near-Ultraviolet Electroluminescence From Polysilanes,” 331 Thin Solid Films 64-70 (1998). These polysilanes emit light having wavelengths in the range from about 320 nm to about 420 nm.

Organic materials having molecular weight less than, for example, about 5000 that are made of a large number of aromatic units are also applicable. An example of such materials is 1,3,5-tris{n-(4-diphenylaminophenyl) phenylamino}benzene, which emits light in the wavelength range of 380-500 nm. The organic EL layer also may be prepared from lower molecular weight organic molecules, such as phenylanthracene, tetraarylethene, coumarin, rubrene, tetraphenylbutadiene, anthracene, perylene, coronene, or their derivatives. These materials generally emit light having maximum wavelength of about 520 nm. Still other suitable materials are the low molecular-weight metal organic complexes such as aluminum-, gallium-, and indium-acetylacetonate, which emit light in the wavelength range of 415-457 nm, aluminum-(picolymethylketone)-bis{2,6-di(t-butyl)phenoxide} or scandium-(4-methoxy-picolylmethylketone)-bis(acetylacetonate), which emits in the range of 420-433 nm. For white light application, the preferred organic EL materials are those emit light in the blue-green wavelengths.

Other suitable organic EL materials that emit in the visible wavelength range are organo-metalic complexes of 8-hydroxyquinoline, such as tris(8-quinolinolato)aluminum and its derivatives. Other non-limiting examples of organic EL materials are disclosed in U. Mitschke and P. Bauerle, “The Electroluminescence of Organic Materials,” J. Mater. Chem., Vol. 10, pp. 1471-1507 (2000).

More than one organic EL layer may be formed successively one on top of another, each layer comprising a different organic EL material that emits in a different wavelength range. Such a construction can facilitate a tuning of the color of the light emitted from the overall light-emitting device 10.

Furthermore, one or more additional layers may be included in light-emitting device 10 further to increase the efficiency thereof. For example, an additional layer can serve to improve the injection and/or transport of positive charges (holes) into the organic EL layer 40. The thickness of each of these layers is kept to below 500 nm, preferably below 100 nm. Suitable materials for these additional layers are low-to-intermediate molecular weight (for example, less than about 2000) organic molecules, poly(3,4-ethylenedioxythipohene) (“PEDOT”), and polyaniline. They may be applied during the manufacture of the device 10 by conventional methods such as spray coating, dip coating, or physical or chemical vapor deposition. In one embodiment of the present invention, as shown in FIG. 3, a hole injection enhancement layer 22 is formed between the anode layer 20 and the organic EL layer 40 to provide a higher injected current at a given forward bias and/or a higher maximum current before the failure of the device. Thus, the hole injection enhancement layer facilitates the injection of holes from the anode. Suitable materials for the hole injection enhancement layer are arylene-based compounds disclosed in U.S. Pat. No. 5,998,803; such as 3,4,9,10-perylenetetra-carboxylic dianhydride or bis(1,2,5-thiadiazolo)-p-quinobis(1,3-dithiole).

In another embodiment of the present invention, as shown in FIG. 4, light-emitting device 10 further includes a hole transport layer 24 which is disposed between the hole injection enhancement layer 22 and the organic EL layer 40. The hole transport layer 24 has the functions of transporting holes and blocking the transportation of electrons so that holes and electrons are optimally combined in the organic EL layer 40. Materials suitable for the hole transport layer are triaryldiamine, tetraphenyldiamine, aromatic tertiary amines, hydrazone derivatives, carbazole derivatives, triazole derivatives, imidazole derivatives, oxadiazole derivatives having an amino group, and polythiophenes as disclosed in U.S. Pat. No. 6,023,371.

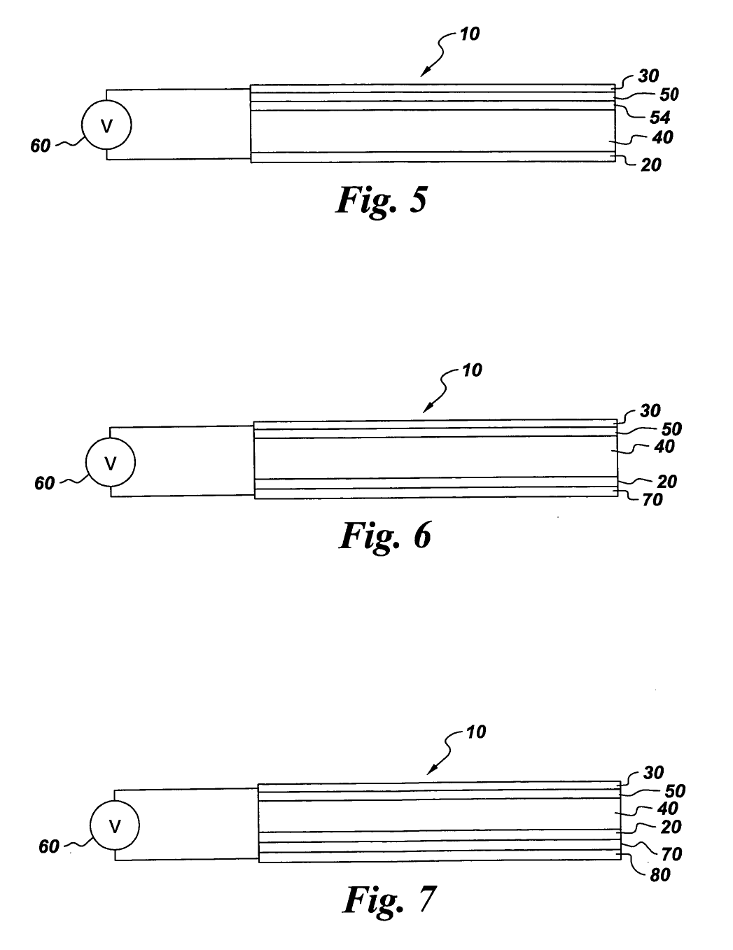

In still another embodiment of the present invention, as shown schematically in FIG. 5, light-emitting device 10 includes an additional layer 54 which can be disposed between electron-donating material 50 and organic EL layer 40. Layer 54 can further enhance the injection and transport of electrons (hereinafter called “electron injecting and transporting enhancement layer”) to organic EL layer 40. Materials suitable for the electron injecting and transporting enhancement layer are metal organic complexes such as tris(8-quinolinolato)aluminum, oxadiazole derivatives, perylene derivatives, pyridine derivatives, pyrimidine derivatives, quinoline derivatives, quinoxaline derivatives, diphenylquinone derivatives, and nitro-substituted fluorene derivatives, as disclosed in U.S. Pat. No. 6,023,371.

In addition, light-emitting device 10 can comprise one or more photoluminescent (“PL”) layers. Such PL layers absorb a portion of light emitted by organic EL layer 40 and convert it to light having different wavelengths, and provide the ability to tune the color of light emitted by the overall device. PL materials can be of an organic or inorganic type.

Organic PL materials typically have rigid molecular structure and are extended π-systems. They typically have small Stokes shifts and high quantum efficiency. For example, organic PL materials that exhibit absorption maxima in the blue portion of the spectrum exhibit emission in the green portion of the spectrum. Similarly, those that exhibit absorption maxima in the green portion of the spectrum exhibit emission the yellow or orange portion of the spectrum. Such small Stokes shifts give the organic PL materials high quantum efficiencies.

Suitable classes of organic PL materials are the perylenes and benzopyrenes, coumarin dyes, polymethine dyes, xanthene dyes, oxobenzanthracene dyes, and perylenebis(dicarboximide) dyes disclosed by Tang et al. in U.S. Pat. No. 4,769,292 which is incorporated herein by reference. Other suitable organic PL materials are the pyrans and thiopyrans disclosed by Tang et al. in U.S. Pat. No. 5,294,870 which is incorporated herein by reference. Still other suitable organic PL materials belong to the class of azo dyes, such as those described in P. F. Gordon and P. Gregory, “Organic Chemistry in Colour,” Springer-Verlag, Berlin, pp. 95-108 (1983). Preferred organic PL materials are those that absorb a portion of the green light emitted by the light-emitting member and emit in the yellow-to-red wavelengths of the visible spectrum. Such emission from these organic PL materials coupled with the portion of unabsorbed light from the light-emitting member produces light that is close to the black-body radiation locus.

The organic PL materials may be deposited on anode 20 of the light-emitting device 10 by physical vapor deposition, spraying, spin coating, dip coating, or printing such as ink-jet printing. They also may be dispersed in a substantially transparent polymeric material such as polyacrylates, polycarbonate, polyethyleneterephthalate (“PET”), silicone, epoxy, or derivatives thereof. Then, the mixture is formed by casting into a film 70 that is subsequently disposed on light-emitting device 10, as shown in FIG. 6.

In another embodiment of the present invention as illustrated in FIG. 7, light-emitting device 10 further comprises a layer 80 comprising at least one inorganic PL material (or a phosphor) that is disposed adjacent to organic PL layer 70. Although organic PL layer 70 is shown in FIG. 7 to be between the anode 20 and inorganic PL layer 80, layer 80 may also be disposed between anode 20 and organic PL layer 70. The particle size and the interaction between the surface of the particle and the polymeric medium determine how well particles are dispersed in polymeric materials to form the film or layer 60. Many micrometer-sized particles of oxide materials, such as zirconia, yttrium and rare-earth garnets, and halophosphates, disperse well in standard silicone polymers, such as poly(dimethylsiloxanes) by simple stirring. If necessary, other dispersant materials (such as a surfactant or a polymeric material like poly(vinyl alcohol)) may be added such as are used to suspend many standard phosphors in solution. The phosphor particles may be prepared from larger pieces of phosphor material by any grinding or pulverization method, such as ball milling using zirconia-toughened balls or jet milling. They also may be prepared by crystal growth from solution, and their size may be controlled by terminating the crystal growth at an appropriate time. The preferred phosphor materials efficiently absorb EM radiation emitted by the organic EL material and re-emit light in another spectral region. Such a combination of the organic EL material and the phosphor allows for a flexibility in tuning the color of light emitted by the light-emitting device 10. A particular phosphor material or a mixture of phosphors may be chosen to emit a desired color or a range of color to complement the color emitted by the organic EL material and that emitted by the organic PL materials. An exemplary phosphor is the cerium-doped yttrium aluminum oxide Y₃Al₅O₁₂ garnet (“YAG:Ce”). Other suitable phosphors are based on YAG doped with more than one type of rare earth ions, such as (Y_{1-x-y}GdₓCe_{y})₃Al₅O₁₂ (“YAG:Gd,Ce”), (Y₁₋ₓCeₓ)₃(Al_{1-y}Ga_{y})O₁₂ (“YAG:Ga,Ce”), (Y_{1-x-y}GdₓCe_{y})(Al_{5-z}Ga_{z})O₁₂ (“YAG:Gd,Ga,Ce”), and (Gd₁₋ₓCeₓ)Sc₂Al₃O₁₂ (“GSAG”) where 0≦x≦1,0≦y≦1, 0≦z≦5 and x+y≦1. For example, the YAG:Gd,Ce phosphor shows an absorption of light in the wavelength range from about 390 nm to about 530 nm (i.e., the blue-green spectral region) and an emission of light in the wavelength range from about 490 nm to about 700 nm (i.e., the green-to-red spectral region). Related phosphors include Lu₃Al₅O₁₂ and Tb₂Al₅O₁₂, both doped with cerium. In addition, these cerium-doped garnet phosphors may also be additionally doped with small amounts of Pr (such as about 0.1-2 mole percent) to produce an additional enhancement of red emission. The following are examples of phosphors that are efficiently excited by EM radiation emitted in the wavelength region of 300 nm to about 500 nm by polysilanes and their derivatives.

Non-limiting examples of green light-emitting phosphors are Ca₈Mg(SiO₄)₄Cl₂:Eu²⁺, Mn²⁺; GdBO₃:Ce³⁺, Tb³⁺; CeMgAl₁₁O₁₉:Tb³⁺; Y₂SiO₅:Ce³⁺, Tb³⁺; and BaMg₂Al₁₆O₂₇:Eu²⁺, Mn²⁺.

Non-limiting examples of red light-emitting phosphors are Y₂O₃:Bi³⁺, Eu³⁺; Sr₂P₂O₇:Eu²⁺, Mn²⁺; SrMgP₂O₇:Eu²⁺, Mn²⁺; (Y,Gd)(V,B)O₄:Eu³⁺; and 3.5MgO.0.5MgF₂.GeO₂: Mn⁴⁺ (magnesium fluorogermanate).

Non-limiting examples of blue light-emitting phosphors are BaMg₂Al₁₆O₂₇:Eu²⁺; Sr₅(PO₄)₁₀Cl₂:Eu²⁺; and (Ba,Ca,Sr)₅(PO₄)₁₀(Cl,F)₂:Eu²⁺, (Ca,Ba,Sr)(Al,Ga)₂S₄:Eu²⁺.

Non-limiting examples of yellow light-emitting phosphors are (Ba,Ca,Sr)₅(PO₄)₁₀(Cl,F)₂:Eu²⁺, Mn²⁺.

Still other ions may be incorporated into the phosphor to transfer energy from the light emitted from the organic material to other activator ions in the phosphor host lattice as a way to increase the energy utilization. For example, when Sb³⁺ and Mn²⁺ ions exist in the same phosphor lattice, Sb³⁺ efficiently absorbs light in the blue region, which is not absorbed very efficiently by Mn²⁺, and transfers the energy to Mn²⁺ ion. Thus, a larger total amount of light emitted by the organic EL material is absorbed by both ions, resulting in higher quantum efficiency of the total device.

The phosphor particles are dispersed in a film-forming polymeric material, such as polyacrylates, substantially transparent silicone or epoxy. A phosphor composition of less than about 30, preferably less than about 10, percent by volume of the mixture of polymeric material and phosphor is used. A solvent may be added into the mixture to adjust the viscosity of the film-forming material to a desired level. The mixture of the film-forming material and phosphor particles is formed into a layer by spray coating, dip coating, printing, or casting on a substrate. Thereafter, the film is removed from the substrate and disposed on the light-emitting device 10. The thickness of film or layers 70 and 80 is preferably less than 1 mm, more preferably less than 500 μm. Preferably, the film-forming polymeric materials have refractive indices close to that of a layer on which layers 70 and 80 are disposed.

### EXAMPLE 4

### Demonstration of Reduction in Work Function of Aluminum Electrode with Sodium Anthracenide

Sodium anthracenide, which was manufactured as disclosed in Example 1, was spin coated onto aluminum. The thickness of the coating was estimated to be between about 1 nm and about 10 nm, as determined by ellipsometry. Contact potential differences (“CPD”) of the surface coated with sodium anthracenide and of bare surface of aluminum, relative to a reference surface, were measured using a Kelvin probe. The work function Φ of a sample surface can be estimated by Equation 7:
Φ(in eV)=4.4−CPD(in V) (Equation 7)

The work function of bare aluminum and of aluminum coated with sodium anthracenide was calculated to be 3.15 and 2.71 eV, respectively. Thus, sodium anthracenide lowered the work function of aluminum, and sodium anthracenide-coated aluminum is a better cathode material.

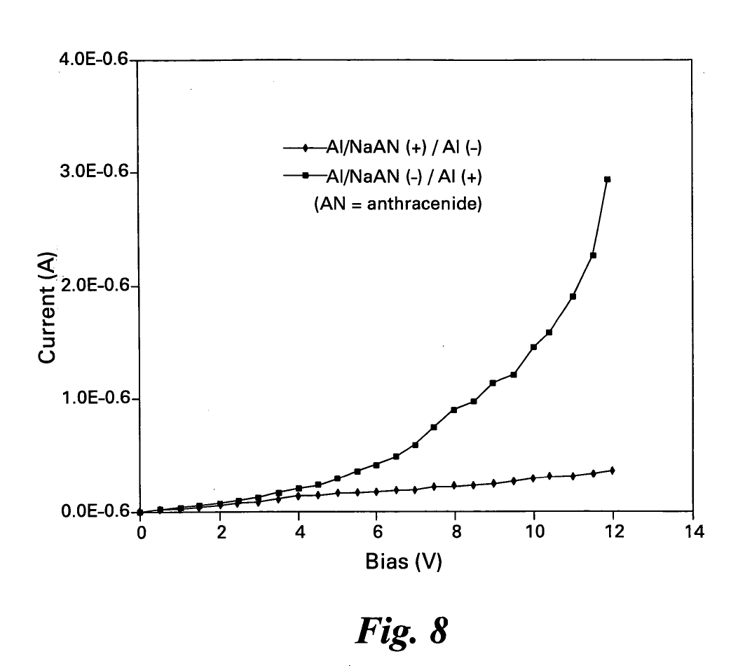

A device was made to demonstrate an enhancement of electron injection from a sodium anthracenide-coated aluminum electrode. Layers of aluminum, sodium anthracenide, an organic EL material, and aluminum were deposited consecutively on a glass substrate. A bias voltage was applied across the two aluminum layers. When the layer of aluminum adjacent to the sodium anthracenide layer was made the cathode, the current began to rise at a lower bias voltage, as shown in FIG. 8. Therefore, electrons were injected more easily from aluminum coated with sodium anthracenide.

### EXAMPLE 5

### Demonstration of Reduction in Work Function of Aluminum Electrode with KNTES

KNTES, which was manufactured as disclosed in Example 2, was spin coated onto aluminum, similarly to the coating of Example 4. CPDs of the surface coated with KNTES and of bare surface of aluminum, relative to a reference surface, were measured using a Kelvin probe. The work function of bare aluminum and of aluminum coated with KNTES was calculated to be 3.2 and 2.6 eV, respectively. Thus, KNTES lowered the work function of aluminum, and KNTES-coated aluminum is a better cathode material.

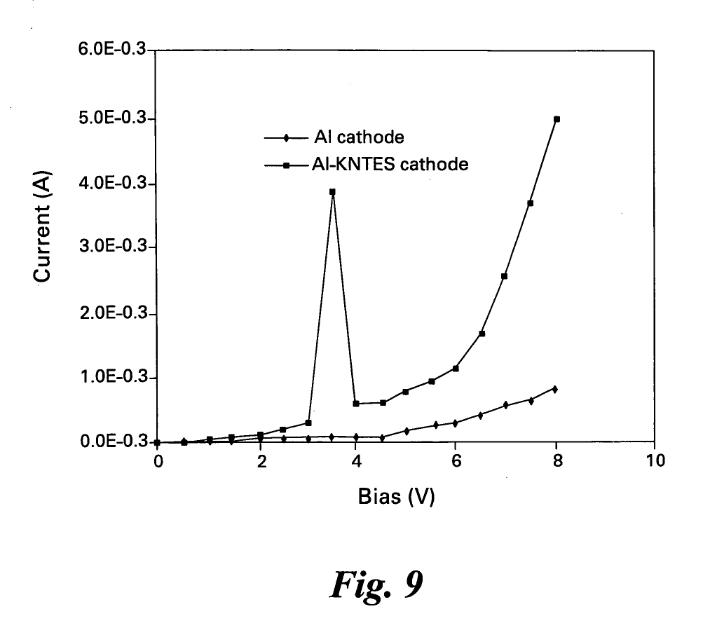

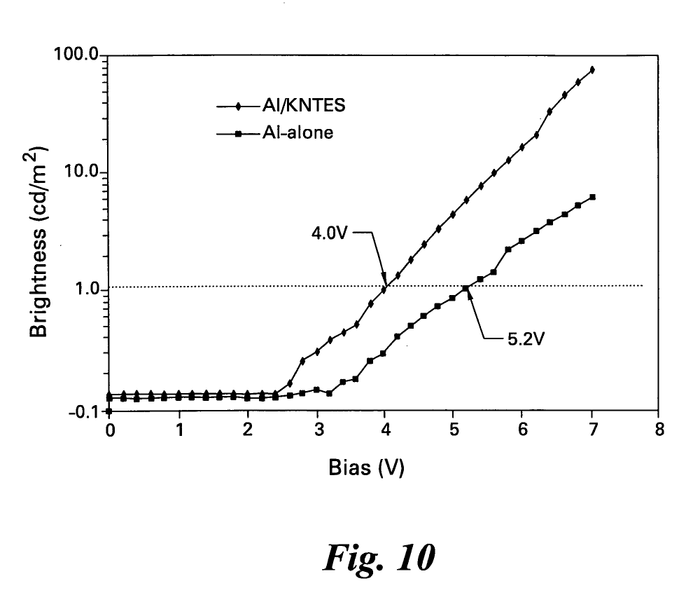

A device was made to demonstrate an enhancement of electron injection from a KNTES-coated aluminum electrode. Layers of aluminum, sodium anthracenide, a blue light-emitting organic EL material based on polyfluorene, and aluminum were deposited consecutively on a glass substrate. A bias voltage was applied across the two aluminum layers. When the layer of aluminum adjacent to the sodium anthracenide layer was made the cathode, the current began to rise at a lower bias voltage, as shown in FIG. 9. Therefore, electrons were injected more easily from aluminum coated with KNTES. FIG. 10 shows the brightness of the devices made with cathodes of aluminum and aluminum coated with KNTES. The device having the cathode made of aluminum coated with KNTES showed a higher brightness at the same bias voltage, indicating a more efficient electron injection into the organic EL material.

### EXAMPLE 6

### Demonstration of Reduction in Work Function of Aluminum Electrode with Crown Ethers and Alkali Fluorides

18-crown-6 was reacted with potassium fluoride in THF solvent as follows. 0.2 g of 18-crown-6 was dissolved in dry THF, followed by addition of 0.02 g KF. The solution was spin coated onto aluminum, which was deposited on glass. The CPD value was measured to be 2.5 V shortly after the spin coating, and 2.05 V after exposure to air overnight.

Similarly, dibenzo21-crown-7 was reacted with cesium fluoride, and the solution was spin coated onto aluminum, which was deposited on glass. The CPD value was measured to be 2.35 V shortly after the spin coating, and 1.91 V after exposure to air overnight.

Thus, the products of the interaction or reaction of crown ethers and alkali fluorides significantly reduced the work function of aluminum electrodes. Such reduction in work function also was quite stable for coated electrodes that were exposed to ambient atmosphere.

### EXAMPLE 7

### Demonstration of Reduction in Work Function of ITO Electrode

Sodium anthracenide, which was manufactured as disclosed in Example 1, was spin coated onto ITO. The work function of bare ITO and of sodium anthracenide-coated ITO was determined (from the contact potential differences obtained from Kelvin probe measurements) to be 4.66 and 3.18 eV, respectively. Thus, sodium anthracenide also lowered the work function of ITO.

KNTES, which was manufactured as disclosed in Example 2, was spin coated onto ITO. The work function of bare ITO and of KNTES-coated ITO was determined (from the contact potential differences obtained from Kelvin probe measurements) to be 4.7 and 3.4 eV, respectively. Thus, KNTES also lowered the work function of ITO.

### EXAMPLE 8

### Organic EL Layer Doped with Sodium Anthracenide

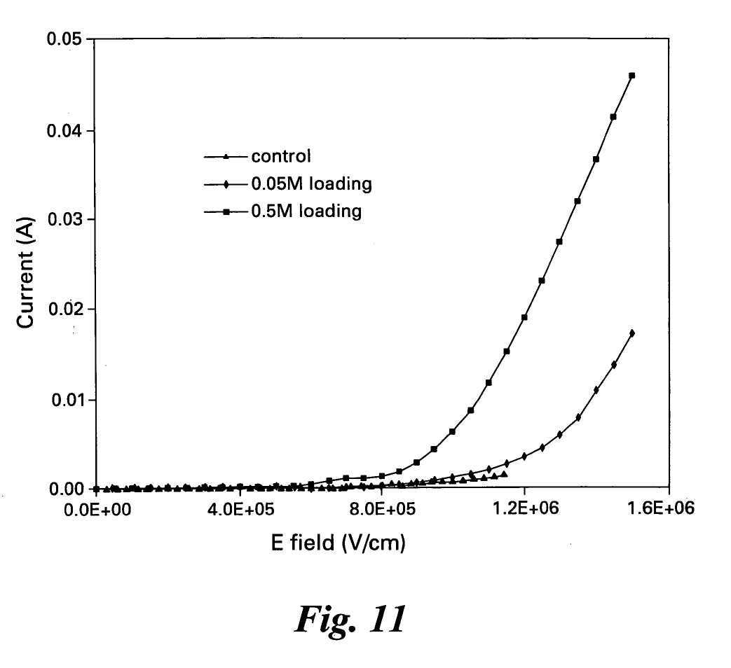

An electron transfer-promoting material of the present invention also can be doped into the organic EL layer to enhance electron injection in an organic EL device. In this example, sodium anthracenide, produced by the method disclosed in Example 1, was doped into a polyfluorene-based light-emitting polymer at levels of 0.05 and 0.5 mole per mole of polymer. EL devices were made with undoped polymer and polymer doped with sodium anthracenide. Each device had an ITO anode, PEDOT (poly(3,4-ethyledioxythiophene)) hole-transport layer, the EL polymer, and an aluminum cathode layer. FIG. 11 shows the current-versus-electric field curves for the devices. Each of the organic layers was deposited by the spin-coating method onto the underlying layer. The device with the higher concentration of sodium anthracenide in the EL polymer showed higher current at the same electric field, indicating an easier electron injection.

Other Electronic Devices

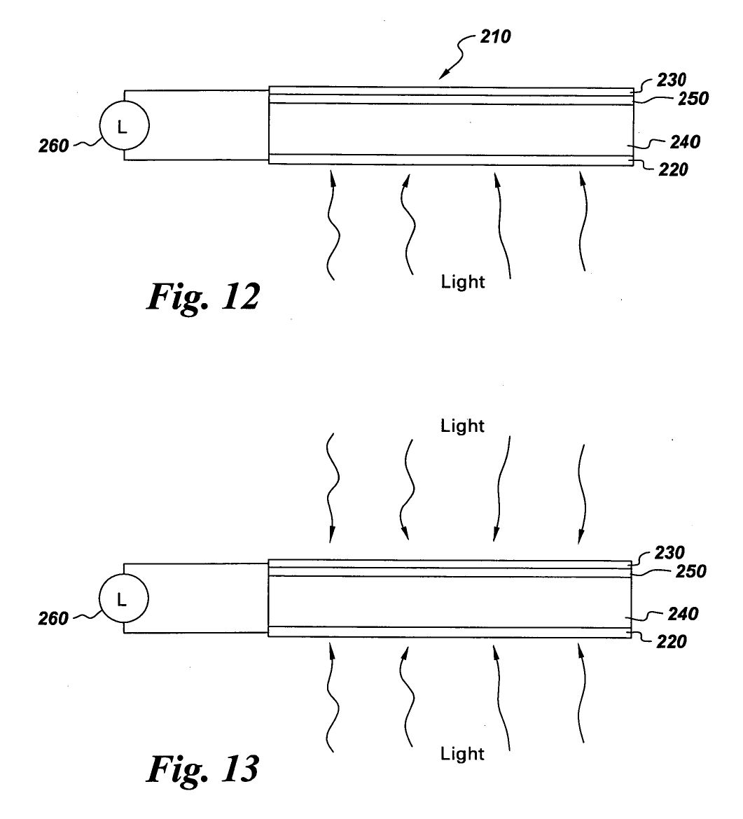

Another type of opto-electronic devices, which can benefit from an efficient transport of electrons across an interface between an electrode and an adjacent opto-electronically active material, are photovoltaic (“PV”) cells. A charge transfer-promoting material of the present invention can be incorporated beneficially into such PV cells. FIG. 12 shows schematically a PV cell 210 comprises a pair of electrodes 220 and 230 and a light-absorbing PV material 240 disposed therebetween. When the PV material 240 is irradiated with light, electrons that have been confined to an atom in the PV material 240 are released by light energy to move freely. Thus, free electrons and holes are generated. Free electrons and holes are efficiently separated so that electric energy is continuously extracted. Free electrons move through the semiconductor PV material 240 and flow through one of the electrodes, for example, electrode 230. In one embodiment, a layer 250 of a charge transfer-promoting material disclosed above is disposed between electrode 230 and semiconductor PV material 240. Electrical load 260 is connected to electrodes 220 and 230 to complete an electrical circuit.

Many types of PV materials 240 can be used with an embodiment of the present invention. For example, PV material 240 may be silicon semiconductor material, a semiconductor material such as TiO₂ sensitized with a photon-absorbing organic dye (or chromophore), or a pair of organic semiconducting materials comprising an electron donor material and an electron acceptor material disposed adjacent to each other to form a p-n junction. In one embodiment, the charge transfer-promoting material is doped into the electron donor material. Non-limiting examples of semiconductor materials are disclosed in U.S. patent application having Ser. No. 10/424,276, filed on Jun. 23, 2003, entitled “Tandem Photovoltaic Cell Stacks,” having the same assignee, which patent application is incorporated herein by reference in its entirety.

Electrode 220 comprises a material selected from the group consisting of materials of electrode 20 disclosed above in conjunction with light-emitting device 10. Electrode 230 comprises a material selected from the group consisting of materials of electrode 30 disclosed above in conjunction with light-emitting device 10. Layer 250 comprises a charge transfer-promoting material selected from those described above in conjunction with layer 50 of light-emitting device 10.

Alternatively, as illustrated in FIG. 13, it may be desirable to allow light to penetrate both electrodes 220 and 230, which are substantially transparent. In such as case, both electrode 230 and layer 250 can be very thin, such as having a thickness of about 1 nm to about 40 nm, preferably less than 20 nm.

A method of making an electronic device is now described. The method comprises: (a) providing a first electrode comprising a first electrically conducting material; (b) disposing a charge transfer-promoting material on the first electrically conducting material; (c) disposing an electronically active material on the charge transfer-promoting material; and (d) providing a second electrode on the electronically active material.

In an embodiment of the method of the present invention, the charge transfer-promoting material comprises a material having at least a formula selected from the group consisting of AM, AMⁿ⁺X⁻ₙ, {A-R³}ⁿ⁻Mⁿ⁺, and {A-R¹—Si—O—(OR²)₃}ⁿ⁻Mⁿ⁺; wherein A is an organic compound selected from the group consisting of fused ring radicals having from 2 to 5 rings, inclusive, and derivatives thereof; M is a metal selected from the group consisting of alkali metals, alkaline-earth metals, scandium, yttrium, and metals of the lanthanide series; X is at least one of halogen elements; R¹ is a straight or branched alkylene radical having from 2 to 5 carbon atoms, inclusive; R² is hydrogen or a straight or branched alkyl radical having from 1 to 5 carbon atoms, inclusive; R³ is selected from the group consisting of alkoxy silane, carboxylic acid, thiol, amine, phosphine, amide, imine, ester, anhydride, and epoxy groups that are covalently bound to A; and n is an integer number selected from the group consisting of 1, 2, and 3. A is preferably a fused aromatic ring radical having 2 or 3 aromatic rings. M is preferably an alkali metal; more preferably, lithium, sodium, potassium, or cesium; and most preferably, lithium, sodium, or potassium.

In another embodiment, the charge transfer-promoting material comprises a material having at least a formula selected from the group consisting of AM, AMⁿ⁺X⁻ₙ, and {A-R³}ⁿ⁻Mⁿ⁺; wherein A is selected from the group consisting of crown ethers, cryptands, macrocyclic polyamine compounds, and derivatives thereof, such as compounds having the formulas IV, V, VIII, IX, X, XI, disclosed above; M and R³ are defined in the immediately foregoing paragraph. Non-limiting examples of the macrocyclic polyamine compounds are 1,4,7,10-tetraazacyclododecane; 1,4,7-triazacyclononane; 1,4,8,11-tetraazacyclotetradecane; 1-oxa-4,7,10-triazacyclododecane; and derivatives thereof.

In another embodiment, the first electrically conducting material comprises a material selected from the group consisting of K, Li, Na, Mg, Ca, Sr, Ba, Al, Ag, In, Sn, Zn, Zr, Sc, Y, elements of the lanthanide series, alloys thereof, or mixtures thereof.

The formation of an inorganic or metallic layer, such as a layer of the first or the second electrode, can be carried out by a method such as physical vapor deposition, chemical vapor deposition, or sputtering.

The formation of an organic layer, such as a layer of an organic light-emitting material, a layer of an organic PV material, or a layer of the charge transfer-promoting material, can be carried out by a method such as spin coating, spray coating, dip coating, roller coating, ink-jet printing, physical vapor deposition, or chemical vapor deposition.

Alternatively, the method of making an electronic device comprises: (a) providing a first substrate; (b) forming a first layer on the first substrate, the first layer comprising a first electrically conducting material; (c) forming a second layer on the first layer, the second layer comprising a charge transfer-promoting material; (d) forming a third layer on the second layer, the third layer comprising an electronically active material; and (e) forming a fourth layer on the third layer, the fourth layer comprising a second electrically conducting material.

In one embodiment, the first electrically conducting material is selected from the group consisting of K, Li, Na, Mg, Ca, Sr, Ba, Al, Ag, In, Sn, Zn, Zr, Sc, Y, elements of the lanthanide series, alloys thereof, or mixtures thereof.

In another embodiment of this method of the present invention, the charge transfer-promoting material comprises a material having at least a formula selected from the group consisting of AM, AMⁿ⁺X⁻ₙ, {A-R³}ⁿ⁻Mⁿ⁺, and {A-R¹—Si—O—(OR²)₃}ⁿ⁻Mⁿ⁺; wherein A is a complexing ligand selected from the group consisting of fused ring radicals having from 2 to 5 rings, inclusive, and derivatives thereof; M is a metal selected from the group consisting of alkali metals, alkaline-earth metals, scandium, yttrium, and metals of the lanthanide series; X is at least one of halogen elements; R¹ is a straight or branched alkylene radical having from 2 to 5 carbon atoms, inclusive; R² is hydrogen or a straight or branched alkyl radical having from 1 to 5 carbon atoms, inclusive; R³ is defined above; and n is an integer number selected from the group consisting of 1, 2, and 3. A is preferably a fused aromatic ring radical having 2 or 3 aromatic rings. M is preferably an alkali metal; more preferably, lithium, sodium, potassium, or cesium; and most preferably, lithium, sodium, or potassium.

In another embodiment, the charge transfer-promoting material comprises a material having at least a formula selected from the group consisting of AM, and AMⁿ⁺X⁻ₙ, wherein A is selected from the group consisting of crown ethers, cryptands, macrocyclic polyamine compounds, and derivatives thereof, such as compounds having the formulas IV, V, VIII, IX, X, XI, disclosed above. Non-limiting examples of the macrocyclic polyamine compounds are 1,4,7,10-tetraazacyclododecane; 1,4,7-triazacyclononane; 1,4,8,11-tetraazacyclotetradecane; 1-oxa-4,7,10-triazacyclododecane; and derivatives thereof.

In another embodiment, the substantially transparent, electrically conducting material of the fourth layer comprises a substantially transparent, electrically conducting metal oxide selected from the group consisting of ITO, tin oxide, indium oxide, zinc oxide, indium zinc oxide, zinc indium tin oxide, antimony oxide, and mixtures thereof.

In still another embodiment of the present invention, the method of making an electronic device comprises: (a) forming a first article, the forming of the first article comprising: (1) providing a first substrate; (2) forming a first layer on the first substrate, the first layer comprising a first electrically conducting material; (3) forming a second layer on the first layer, the second layer comprising a charge transfer-promoting material; and (4) forming a third layer on the second layer, the third layer comprising an electronically active material; (b) forming a second article, the forming of the second article comprising: (1) providing a second substrate; and (2) forming a fourth layer on the second substrate, the fourth layer comprising a second electrically conducting material; and (c) laminating together the first article and the second article such that the fourth layer is disposed adjacent to the third layer.

In still another embodiment of the present invention, the method of making an electronic device comprises: (a) forming a first article, the forming of the first article comprising: (1) providing a first substrate; (2) forming a first layer on the first substrate, the first layer comprising a first electrically conducting material; and (3) forming a second layer on the first layer, the second layer comprising a charge transfer-promoting material; (b) forming a second article, the forming of the second article comprising: (1) providing a second substrate; (2) forming a fourth layer on the second substrate, the fourth layer comprising a second electrically conducting material; and (3) forming a third layer on the fourth layer, the third layer comprising an electronically active material; and (c) laminating together the first article and the second article such that the second layer is disposed adjacent to the third layer.

In still another embodiment, laminating together the first article and the second article is carried out by applying heat or pressure to the articles after they are brought together.

In another embodiment of the present invention, the method of making an electronic device, such as an opto-electronic device, comprises: (a) forming a first article, the forming of the first article comprising: (1) providing a first substrate; (2) forming a first layer on the first substrate, the first layer comprising an electrically conducting material; (3) forming a second layer on the first layer, the second layer comprising a charge transfer-promoting material; and (4) forming a protective layer on the second layer, the protective layer comprising a material that is capable of being removed to expose the second layer; (b) removing the protective layer to expose the second layer; (c) forming a third layer on the second layer, the third layer comprising an electronically active material, such as an opto-electronically active material; and (d) forming a fourth layer on the third layer, the fourth layer comprising a second electrically conducting material.

In still another embodiment, removing the protective layer is carried out in an enclosure, which provides a clean environment to prevent an attack by chemically reactive species present in the environment on the material comprising the first and second layers.

In yet another embodiment, the protective layer can be an organic polymer, and removing the protective layer is carried out by a method such as heating or laser ablation.

In yet another embodiment, the method of making an electronic device comprises: (a) providing a first layer of a first electrically conducting material; (b) forming a second layer on the first layer, the second layer comprising an electronically active material doped with a charge transfer-promoting material; and (c) disposing a third layer on the second layer, the third layer comprising a second electrically conducting material.

In yet another embodiment, the method further comprises disposing at least one additional layer between one of the electrodes and the layer of the electronically active material. Said at least one additional layer comprises a material capable of enhancing the transport or injection of at least a charge species to an adjacent layer.

While various embodiments are described herein, it will be appreciated from the specification that various combinations of elements, variations, equivalents, or improvements therein may be made by those skilled in the art, and are still within the scope of the invention as defined in the appended claims.

1. A charge transfer-promoting material comprising a material having at least a formula selected from the group consisting of AM, AMⁿ⁺X⁻ₙ, and {A-R³}ⁿ⁻Mⁿ⁺; wherein A is an organic moiety selected from the group consisting of fused ring radicals having from 2 to 5 rings, inclusive, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

2. A charge transfer-promoting material comprising a material having at least a formula selected from the group consisting of AM, AMⁿ⁺X⁻ₙ, and {A-R³}ⁿ⁻Mⁿ⁺; wherein A is an organic moiety selected from the group consisting of crown ethers, cryptands, macrocyclic polyamines, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

3. The charge transfer-promoting material of claim 1; wherein A is a fused aromatic ring radical having from 2 to 3 rings, inclusive, and derivatives thereof.

4. The charge transfer-promoting material of claim 1, wherein M is an alkali metal.

5. The charge transfer-promoting material of claim 2, wherein A is a crown ether.

6. The charge transfer-promoting material of claim 2, wherein M is an alkali metal.

7. The charge transfer-promoting material of claim 2, comprising potassium triethoxysilylnapthalene.

8. The charge transfer-promoting material of claim 2, wherein A is 18-crown-6 and M is potassium.

9. The charge transfer-promoting material of claim 2, comprising a reaction product of compound VIII and potassium fluoride.

10. An article comprising a first metal and a charge transfer-promoting material disposed on the first metal; wherein the charge transfer-promoting material comprising a material having at least a formula selected from the group consisting of AM, AMⁿ⁺X⁻ₙ, and {A-R³}ⁿ⁻Mⁿ⁺; wherein A is an organic moiety selected from the group consisting of fused ring radicals having from 2 to 5 rings, inclusive, and derivatives thereof; R³ is selected from the group consisting of alkoxy silane, carboxylic acid, thiol, amine, phosphine, amide, imine, ester, anhydride, and epoxy, and is covalently attached to A; M is a second metal selected from the group consisting of alkali metals, alkaline-earth metals, scandium, yttrium, and metals of lanthanide series; X is a halogen element; and n is an integer number selected from the group consisting of 1, 2, and 3.

11. The article of claim 10, wherein A is a fused aromatic ring radical having from 2 to 3 rings, inclusive, and derivatives thereof.

12. The article of claim 10, wherein M is an alkali metal.

13. The article of claim 10, wherein the charge transfer-promoting material forms a layer on a surface of the first metal.

14. The article of claim 10, wherein the first metal and the second metal comprise the same metal.

15. The article of claim 10, wherein the first metal and the second metal are different metals.

16. The article of claim 10, wherein the first metal is aluminum and the charge transfer-promoting material comprises potassium triethoxysilylnaphthalene.

17. An article comprising a first metal and a charge transfer-promoting material disposed on the first metal; wherein the charge transfer-promoting material comprising a material having at least a formula selected from the group consisting of AM, AMⁿ⁺X⁻ₙ, and {A-R³}ⁿ⁻Mⁿ⁺; wherein A is an organic moiety selected from the group consisting of crown ethers, cryptands, macrocyclic polyamines, and derivatives thereof; R³ is selected from the group consisting of alkoxy silane, carboxylic acid, thiol, amine, phosphine, amide, imine, ester, anhydride, and epoxy, and is covalently attached to A; M is a second metal selected from the group consisting of alkali metals, alkaline-earth metals, scandium, yttrium, and metals of lanthanide series; X is a halogen element; and n is an integer number selected from the group consisting of 1, 2, and 3.

18. The article of clam 17, wherein A is a crown ether.

19. The article of claim 17, wherein M is an alkali metal.

20. The article of claim 17, wherein the first metal is aluminum and the charge transfer-promoting material has a formula of AMⁿ⁺Xⁿ⁻, wherein A is 18-crown-6, M is potassium, X is fluorine, and n is equal to 1.

21. An electronic device comprising:
(a) a first electrode;
(b) a charge transfer-promoting material disposed on the first electrode, the charge transfer-promoting material comprising a material having at least a formula selected from the group consisting of AM, AMⁿ⁺X⁻ₙ, and {A-R³}ⁿ⁻Mⁿ⁺; wherein A is an organic moiety selected from the group consisting of fused ring radicals having from 2 to 5 rings, inclusive, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3;
(c) at least an electronically active material disposed adjacent to the charge transfer-promoting material; and
(d) a second electrode disposed adjacent to the electronically active material.

22. The electronic device of claim 21; wherein the electronically active material is an organic electroluminescent (“EL”) material; the first electrode comprises a material selected from the group consisting of K, Li, Na, Mg, Ca, Sr, Ba, Al, Ag, In, Sn, Zn, Zr, Sc, Y, elements of lanthanide series, alloys thereof, and mixtures thereof;

23. The electronic device of claim 22, wherein the first electrode comprises aluminum.

24. The electronic device of claim 21; wherein the electronically active material is an organic EL material and is selected from the group consisting of poly(n-vinylcarbazole) (“PVK”), polyfluorene, poly(alkylfluorene), poly(praraphenylene), poly(p-phenylene vinylene), polysilanes, polythiophene, poly(2,5-thienylene vinylene), poly(pyridine vinylene), polyquinoxaline, polyquinoline, 1,3,5-tris{n-(4-diphenylaminophenyl) phenylamino}benzene, phenylanthracene, tetraarylethene, coumarin, rubrene, tetraphenylbutadiene, anthracene, perylene, coronene, and derivatives thereof.

25. The electronic device of claim 21; wherein the electronically active material is an organic EL material and is selected from the group consisting of aluminum-acetylacetonate, gallium-acetylacetonate, and indium-acetylacetonate, aluminum-(picolymethylketone)-bis {2,6-di(t-butyl)phenoxide}, scandium-(4-methoxy-picolylmethylketone)-bis(acetylacetonate), organo-metalic complexes of 8-hydroxyquinoline, and derivatives of organo-metalic complexes of 8-hydroxyquinoline.

26. The electronic device of claim 21, wherein the second electrode comprises a metal oxide selected from the group consisting of indium tin oxide (“ITO”), tin oxide, indium oxide, zinc oxide, indium zinc oxide, zinc indium tin oxide, antimony oxide, and mixtures thereof.

27. The electronic device of claim 21, wherein the electronically active material is an organic EL material, and the electronic device further comprises a photoluminescent (“PL”) material disposed in a path of light emitted by the organic EL material.

28. The electronic device of claim 21, wherein the electronic device is a photovoltaic (“PV”) cell, and the electronically active material is a PV material.

29. The electronic device of claim 28, wherein the PV material comprises an electron-accepting material and an electron-donating material disposed adjacent to each other, and the charge transfer-promoting material is disposed adjacent to the electron-donating material.

30. An electronic device comprising:
(a) a first electrode;
(b) a second electrode; and
(c) at least an electronically active material disposed between the first electrode and the second electrode; said at least an electronically active material being doped with a charge transfer-promoting material that comprises a material having at least a formula selected from the group consisting of AM, AMⁿ⁺X⁻ₙ, and {A-R³}ⁿ⁻Mⁿ⁺; wherein A is an organic moiety selected from the group consisting of fused ring radicals having from 2 to 5 rings, inclusive, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

31. The electronic device of claim 30; wherein the electronically active material is an organic EL material; the first electrode comprises a material selected from the group consisting of K, Li, Na, Mg, Ca, Sr, Ba, Al, Ag, In, Sn, Zn, Zr, Sc, Y, elements of lanthanide series, alloys thereof, and mixtures thereof.

32. The electronic device of claim 30; wherein the electronically active material is an organic EL material and is selected from the group consisting of poly(n-vinylcarbazole) (“PVK”), polyfluorene, poly(alkylfluorene), poly(praraphenylene), poly(p-phenylene vinylene), polysilanes, polythiophene, poly(2,5-thienylene vinylene), poly(pyridine vinylene), polyquinoxaline, polyquinoline, 1,3,5-tris{n-(4-diphenylaminophenyl) phenylamino}benzene, phenylanthracene, tetraarylethene, coumarin, rubrene, tetraphenylbutadiene, anthracene, perylene, coronene, and derivatives thereof.

33. The electronic device of claim 30; wherein the electronically active material is an organic EL material and is selected from the group consisting of aluminum-acetylacetonate, gallium-acetylacetonate, and indium-acetylacetonate, aluminum-(picolymethylketone)-bis {2,6-di(t-butyl)phenoxide}, scandium-(4-methoxy-picolylmethylketone)-bis(acetylacetonate), organo-metalic complexes of 8-hydroxyquinoline, and derivatives of organo-metalic complexes of 8-hydroxyquinoline.

34. The electronic device of claim 30, wherein the second electrode comprises a metal oxide selected from the group consisting of indium tin oxide, tin oxide, indium oxide, zinc oxide, indium zinc oxide, zinc indium tin oxide, antimony oxide, and mixtures thereof.

35. The electronic device of claim 30, wherein the electronically active material is an organic EL material, and the electronic device further comprises a photoluminescent material disposed in a path of light emitted by the organic EL material.

36. The electronic device of claim 30; wherein the electronic device is a PV cell, the electronically active material comprises an electron-accepting material and an electron-donating material disposed adjacent to each other, and the charge transfer-promoting material is doped into the electron-donating material.

37. The electronic device of claim 30, wherein both the first electrode and the second electrode comprise a substantially transparent, electrically conducting material.

38. An electronic device comprising:
(a) a first electrode;
(b) a charge transfer-promoting material disposed on the first electrode, the charge transfer-promoting material comprising a material having at least a formula selected from the group consisting of AM, AMⁿ⁺X⁻ₙ, and {A-R³}ⁿ⁻Mⁿ⁺; wherein A is an organic moiety selected from the group consisting of crown ethers, cryptands, macrocyclic polyamines, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3;
(c) at least an electronically active material disposed adjacent to the charge transfer-promoting material; and
(d) a second electrode disposed adjacent to the electronically active material.

39. An electronic device comprising:
(a) a first electrode;
(b) a second electrode; and
(c) at least an electronically active material disposed between the first electrode and the second electrode; said at least an electronically active material being doped with a charge transfer-promoting material that comprises a material having at least a formula selected from the group consisting of AM, AMⁿ⁺X⁻ₙ, and {A-R³}ⁿ⁻Mⁿ⁺; wherein A is an organic moiety selected from the group consisting of crown ethers, cryptands, macrocyclic polyamines, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

40. A method of making a charge transfer-promoting material having a formula of AM; wherein A is an organic moiety selected from the group consisting of fused ring radicals having from 2 to 5 rings, inclusive, and derivatives thereof; and M is a metal selected from the group consisting of alkali metals, alkaline-earth metals, scandium, yttrium, and metals of lanthanide series; the method comprising reacting a compound having the organic moiety with the metal at a temperature and for a time sufficient to produce the charge transfer-promoting material.

41. The method of claim 40, wherein M is an alkali metal.

42. A method of making a charge transfer-promoting material having a formula of {A-R¹—Si—O—(OR²)₃}ⁿ⁻Mⁿ⁺, the method comprising:
(a) reacting a material having a formula of A-R¹ with (R²O)₃SiH at a temperature and for a time sufficient to produce a first product; and
(b) reacting the first product with a species comprising a metal M at a temperature for a sufficient time to produce the charge transfer-promoting material;
wherein A is selected from the group consisting of fused aromatic ring radicals having from 2 to 5 rings, inclusive, and derivatives thereof; M is a metal selected from the group consisting of alkali metals, alkaline-earth metals, scandium yttrium, and metals of lanthanide series; R¹ is selected from the group consisting of straight alkylene radicals having from 2 to 5 carbon atoms, inclusive, and branched alkylene radicals having from 2 to 5 carbon atoms, inclusive; R² is selected from the group consisting of hydrogen, straight alkyl radicals having from 1 to 5 carbon atoms, inclusive, and branched alkyl radicals having from 1 to 5 carbon atoms, inclusive; R⁴ is a double bond-terminated hydrocarbon group having 2 to 5 carbon atoms; and n is an integer number selected from the group consisting of 1, 2, and 3.

43. The method of claim 42, wherein R⁴ is selected from the group consisting of —CH═CH₂ and —CH₂—CH═CH₂.

44. The method of claim 42, wherein M is an alkali metal.

45. The method of claim 42, wherein the fused aromatic ring radicals comprise from 2 to 3 aromatic rings, inclusive.

46. A method for making an electronic device, the method comprising:
(a) providing a first electrode comprising a first electrically conducting material;
(b) disposing a charge transfer-promoting material on the first electrically conducting material;
(c) disposing an electronically active material on the charge transfer-promoting material; and
(d) providing a second electrode on the electronically active material;
wherein the charge transfer-promoting material comprises a material having at least a formula selected from the group consisting of AM, AMⁿ⁺X⁻ₙ, and {A-R³}ⁿ⁻Mⁿ⁺; wherein A is an organic moiety selected from the group consisting of fused ring radicals having from 2 to 5 rings, inclusive, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

47. The method of claim 46; wherein M is an alkali metal.

48. The method of claim 46, wherein said disposing said charge transfer-promoting material is carried out by a method selected from the group consisting of spin coating, spray coating, dip coating, roller coating, ink-jet printing, physical vapor deposition, and chemical vapor deposition.

49. The method of claim 46, wherein the electronically active material is selected from the group consisting of organic EL materials and PV materials.

50. A method for making an electronic device, the method comprising:
(a) providing a first electrode comprising a first electrically conducting material;
(b) disposing a charge transfer-promoting material on the first electrically conducting material;
(c) disposing an electronically active material on the charge transfer-promoting material; and
(d) providing a second electrode on the electronically active material;
wherein the charge transfer-promoting material comprises a material having at least a formula selected from the group consisting of AM, AMⁿ⁺X⁻ₙ, and {A-R³}ⁿ⁻Mⁿ⁺; wherein A is an organic moiety selected from the group consisting of crown ethers, cryptands, macrocyclic polyamines, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

51. A method of making an electronic device, the method comprising:
(a) forming a first article, the forming of the first article comprising: (1) providing a first substrate; (2) forming a first layer on the first substrate, the first layer comprising a first electrically conducting material; (3) forming a second layer on the first layer, the second layer comprising a charge transfer-promoting material; and (4) forming a third layer on the second layer, the third layer comprising an electronically active material;
(b) forming a second article, the forming of the second article comprising: (1) providing a second substrate; and (2) forming a fourth layer on the second substrate, the fourth layer comprising a second electrically conducting material; and
(c) laminating together the first article and the second article such that the fourth layer is disposed adjacent to the third layer; wherein the charge transfer-promoting material comprises a material having at least a formula selected from the group consisting of AM, AMⁿ⁺X⁻ₙ, and {A-R³}ⁿ⁻Mⁿ⁺; wherein A is an organic moiety selected from the group consisting of fused ring radicals having from 2 to 5 rings, inclusive, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

52. The method of claim 51, wherein the electronically active material is selected from the group consisting of organic EL materials and PV materials.

53. A method of making an electronic device, the method comprising:
(a) forming a first article, the forming of the first article comprising: (1) providing a first substrate; (2) forming a first layer on the first substrate, the first layer comprising a first electrically conducting material; (3) forming a second layer on the first layer, the second layer comprising a charge transfer-promoting material; and (4) forming a third layer on the second layer, the third layer comprising an electronically active material;
(b) forming a, second article, the forming of the second article comprising: (1) providing a second substrate; and (2) forming a fourth layer on the second substrate, the fourth layer comprising a second electrically conducting material; and
(c) laminating together the first article and the second article such that the fourth layer is disposed adjacent to the third layer;
wherein the charge transfer-promoting material comprising a material having at least a formula selected from the group consisting of AM, AMⁿ⁺X⁻ₙ, {A-R³}ⁿ⁻Mⁿ⁺; wherein A is an organic moiety selected from the group consisting of crown ethers, cryptands, macrocyclic polyamines, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

54. The method of claim 53, wherein the electronically active material is selected from the group consisting of organic EL materials and PV materials.

55. The method of claim 53, wherein said laminating is carried out by bringing together the first article and the second article, and applying one of pressure or heat to the articles.

56. A method of making an electronic device, the method comprising:
(a) forming a first article, the forming of the first article comprising: (1) providing a first substrate; (2) forming a first layer on the first substrate, the first layer comprising a first electrically conducting material; and (3) forming a second layer on the first layer, the second layer comprising a charge transfer-promoting material;
(b) forming a second article, the forming of the second article comprising: (1) providing a second substrate; (2) forming a fourth layer on the second substrate, the fourth layer comprising a second electrically conducting material; and (3) forming a third layer on the fourth layer, the third layer comprising an electronically active material; and
(c) laminating together the first article and the second article such that the second layer is disposed adjacent to the third layer;
wherein the charge transfer-promoting material comprising a material having material having at least a formula selected from the group consisting of AM, AMⁿ⁺X⁻ₙ, and {A-R³}ⁿ⁻Mⁿ⁺; wherein A is an organic moiety selected from the group consisting of fused ring radicals having from 2 to 5 rings, inclusive, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

57. The method of claim 56, wherein the electronically active material is selected from the group consisting of organic EL materials and PV materials.

58. The method of claim 56, wherein said laminating is carried out by bringing together the first article and the second article, and applying one of pressure or heat to the articles.

59. A method of making an electronic device, the method comprising:
(a) forming a first article, the forming of the first article comprising: (1) providing a first substrate; (2) forming a first layer on the first substrate, the first layer comprising an electrically conducting material; (3) forming a second layer on the first layer, the second layer comprising a charge transfer-promoting material; and (4) forming a protective layer on the second layer, the protective layer comprising a material that is capable of being removed to expose the second layer;
(b) removing the protective layer to expose the second layer;
(c) forming a third layer on the second layer, the third layer comprising an electronically active material; and
(d) forming a fourth layer on the third layer, the fourth layer comprising a second electrically conducting material;
wherein the charge transfer-promoting material comprising a material having at least a formula selected from the group consisting of AM, AMⁿ⁺X⁻ₙ, and {A-R³}ⁿ⁻Mⁿ⁺; wherein A is an organic moiety selected from the group consisting of fused ring radicals having from 2 to 5 rings, inclusive, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

60. The method of claim 59, wherein the electronically active material is selected from the group consisting of organic EL materials and PV materials.

61. A method of making an electronic device, the method comprising:
(a) providing a first layer of a first electrically conducting material;
(b) forming a second layer on the first layer, the second layer comprising an electronically active material doped with a charge transfer-promoting material; and
(c) disposing a third layer on the second layer, the third layer comprising a second electrically conducting material;
wherein the charge transfer-promoting material comprising a material having material having at least a formula selected from the group consisting of AM, AMⁿ⁺X⁻ₙ, and {A-R³}ⁿ⁻Mⁿ⁺; wherein A is an organic moiety selected from the group consisting of fused ring radicals having from 2 to 5 rings, inclusive, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

62. The method of claim 61, wherein the electronically active material is selected from the group consisting of organic EL materials and PV materials.

63. A method of making an electronic device, the method comprising:
(a) forming a first article, the forming of the first article comprising: (1) providing a first substrate; (2) forming a first layer on the first substrate, the first layer comprising a first electrically conducting material; and (3) forming a second layer on the first layer, the second layer comprising a charge transfer-promoting material;
(b) forming a second article, the forming of the second article comprising: (1) providing a second substrate; (2) forming a fourth layer on the second substrate, the fourth layer comprising a second electrically conducting material; and (3) forming a third layer on the fourth layer, the third layer comprising an electronically active material; and
(c) laminating together the first article and the second article such that the second layer is disposed adjacent to the third layer;
wherein the charge transfer-promoting material comprising a material having at least a formula selected from the group consisting of AM, AMⁿ⁺X⁻ₙ, and {A-R³}ⁿ⁻Mⁿ⁺; wherein A is an organic moiety selected from the group consisting of crown ethers, cryptands, macrocyclic polyamines, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

64. The method of claim 63, wherein the electronically active material is selected from the group consisting of organic EL materials and PV materials.

65. The method of claim 58, wherein said laminating is carried out by bringing together the first article and the second article, and applying one of pressure or heat to the articles.

66. A method of making an electronic device, the method comprising:
(a) forming a first article, the forming of the first article comprising: (1) providing a first substrate; (2) forming a first layer on the first substrate, the first layer comprising an electrically conducting material; (3) forming a second layer on the first layer, the second layer comprising a charge transfer-promoting material; and (4) forming a protective layer on the second layer, the protective layer comprising a material that is capable of being removed to expose the second layer;
(b) removing the protective layer to expose the second layer;
(c) forming a third layer on the second layer, the third layer comprising an electronically active material; and
(d) forming a fourth layer on the third layer, the fourth layer comprising a second electrically conducting material;
wherein the charge transfer-promoting material comprising a material having at least a formula selected from the group consisting of AM, AMⁿ⁺X⁻ₙ, and {A-R³}ⁿ⁻Mⁿ⁺; wherein A is an organic moiety selected from the group consisting of crown ethers, cryptands, macrocyclic polyamines, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

67. The method of claim 66, wherein the electronically active material is selected from the group consisting of organic EL materials and PV materials.

68. A method of making an electronic device, the method comprising:
(a) providing a first layer of a first electrically conducting material;
(b) forming a second layer on the first layer, the second layer comprising an electronically active material doped with a charge transfer-promoting material; and
(c) disposing a third layer on the second layer, the third layer comprising a second electrically conducting material;
wherein the charge transfer-promoting material comprising a material having at least a formula selected from the group consisting of AM, AMⁿ⁺X⁻ₙ, and {A-R³}ⁿ⁻Mⁿ⁺; wherein A is an organic moiety selected from the group consisting of crown ethers, cryptands, macrocyclic polyamines, and derivatives thereof; R³ is selected from the group consisting of alkoxy silane, carboxylic acid, thiol, amine, phosphine, amide, imine, ester, anhydride, and epoxy, and is covalently attached to A; M is a metal selected from the group consisting of alkali metals, alkaline-earth metals, scandium, yttrium, and metals of lanthanide series; X is a halogen element; and n is an integer number selected from the group consisting of 1, 2, and 3.

69. The method of claim 68, wherein the electronically active material is selected from the group consisting of organic EL materials and PV materials.
